(19) United States
(12) Patent Application Publication
(10) Pub. No.: US 2008/0183630 A1
(43) Pub. Date: Jul. 31, 2008

(54) PAY STATION-BASED SYSTEM AND METHOD FOR DOCUMENT PROCESSING

(76) Inventor: Ken STEPHENSON, San Clemente, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/751,394

(22) Filed: May 21, 2007

Related U.S. Application Data
(60) Provisional application No. 60/886,743, filed on Jan. 26, 2007.

(51) Int. Cl. H04L 9/00

(52) U.S. Cl. 705/75

(57) ABSTRACT

The subject application is directed to a pay station-based kiosk system and method for document processing. A document processing device receives a document processing request and calculates costs associated with the performance thereof. Transaction identification data is then received from an associated user and compared to common identifier data. When the transaction identification data and the common identifier data match, the device prompts the user to pay at a counter at the service provider location and then performs the requested operation. The details of the transaction are then communicated to the server for storage in a database thereon in association with service provider data.

### CROSS-REFERENCE TO RELATED APPLICATIONS

This Application claims priority to U.S. Provisional Patent Application Ser. No. 60/886,743, entitled A SYSTEM AND METHOD FOR PROVIDING DOCUMENT PROCESSING SERVICES VIA POINT-OF-SALE TRANSACTIONS filed Jan. 26, 2007, the entirety of which is incorporated herein.

### BACKGROUND OF THE INVENTION

The subject application is directed to a pay station-based kiosk system and method for document processing. More particularly, the subject application is directed to a system and method for remotely monitoring and recording document processing transactions.

Stand-alone document processing devices, document processing service stores, and other document processing service providers are generally limited in the manner in which payment for services may be collected. Typical payment methods are limited to credit cards, prepaid cards, billing to a user account, or the like. While these payment methods are acceptable for some users, other users require additional methods for payment, e.g., the ability to pay cash to a customer service provider. At odds with this desire to pay cash is the necessity of the document processing services provider to be able to accurately track and rectify costs, revenues, and the like. Thus, the document processing service providers do not typically offer cash-payment at a point-of-sale location, as there are no means for accurately tracking the type of transaction, resources used, device used, etc., associated with a transaction when the user is paying cash. Stated another way, records are not easily and automatically kept corresponding to these important components of a document processing service transaction.

### SUMMARY OF THE INVENTION

In accordance with one embodiment of the subject application, there is provided a pay station-based kiosk system and method for document processing.

Further, in accordance with one embodiment of the subject application, there is provided a system and method for remotely monitoring and recording document processing transactions.

Still further, in accordance with one embodiment of the subject application, there is provided a system and method for communicating transaction data to backend server corresponding to a document processing operation.

Further, in accordance with one embodiment of the subject application, there is provided a pay station-based kiosk document processing system. The system includes a plurality of commonly controlled document processing stations. Each document processing station includes means adapted for performing at least one document processing operation on at least one selected electronic document. Each station also includes means adapted for generating fee data corresponding with each document processing operation and means adapted for accessing common identifier data. In addition, each station includes means adapted for receiving transaction identifier data from a portable data storage and means adapted for outputting billing data when the transaction identifier matches the common identifier data. Furthermore, each document processing station includes means adapted for communicating debit data associated with the portable data storage when the transaction identifier fails to match the common identifier data. The system also includes a pay station associated with each document processing station, with the pay station including means adapted for receiving billing data from each of the document processing stations.

In one embodiment of the subject application, the system further comprises means adapted for generating an error signal when the transaction identifier data corresponds to unknown identifier data.

In another embodiment of the subject application, the system also comprises means adapted for selectively outputting the billing data to the pay station upon receipt of a request from an associated user.

In yet another embodiment of the subject application, the portable data storage is comprised of a pre-paid debit card.

In a further embodiment of the subject application, the billing data includes data corresponding to a completed document processing operation.

In one embodiment of the subject application, the pay station includes means adapted for receiving payment associated with received billing data.

Still further, in accordance with one embodiment of the subject application, there is provided a method for pay station-based document processing in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the pay station-based kiosk document processing system according to one embodiment of the subject application;

FIG. 2 is a block diagram illustrating device hardware for use in the pay station-based kiosk document processing system according to one embodiment of the subject application;

FIG. 3 is a functional diagram illustrating the device for use in the pay station-based kiosk document processing system according to one embodiment of the subject application;

FIG. 4 is a block diagram illustrating controller hardware for use in the pay station-based kiosk document processing system according to one embodiment of the subject application;

FIG. 5 is a functional diagram illustrating the controller for use in the pay station-based kiosk document processing system according to one embodiment of the subject application;

FIG. 6 is a block diagram illustrating server hardware for use in the pay station-based kiosk document processing system according to one embodiment of the subject application;

FIG. 7 is a flowchart illustrating a method for pay station-based document processing according to one embodiment of the subject application;

FIG. 8 is a flowchart illustrating a method for pay station-based document processing from a server point of view according to one embodiment of the subject application; and

FIG. 9 is a flowchart illustrating a method for pay station-based document processing from a device point of view according to one embodiment of the subject application.

### DETAILED DESCRIPTION OF THE PREFERRED EMBODIMENT

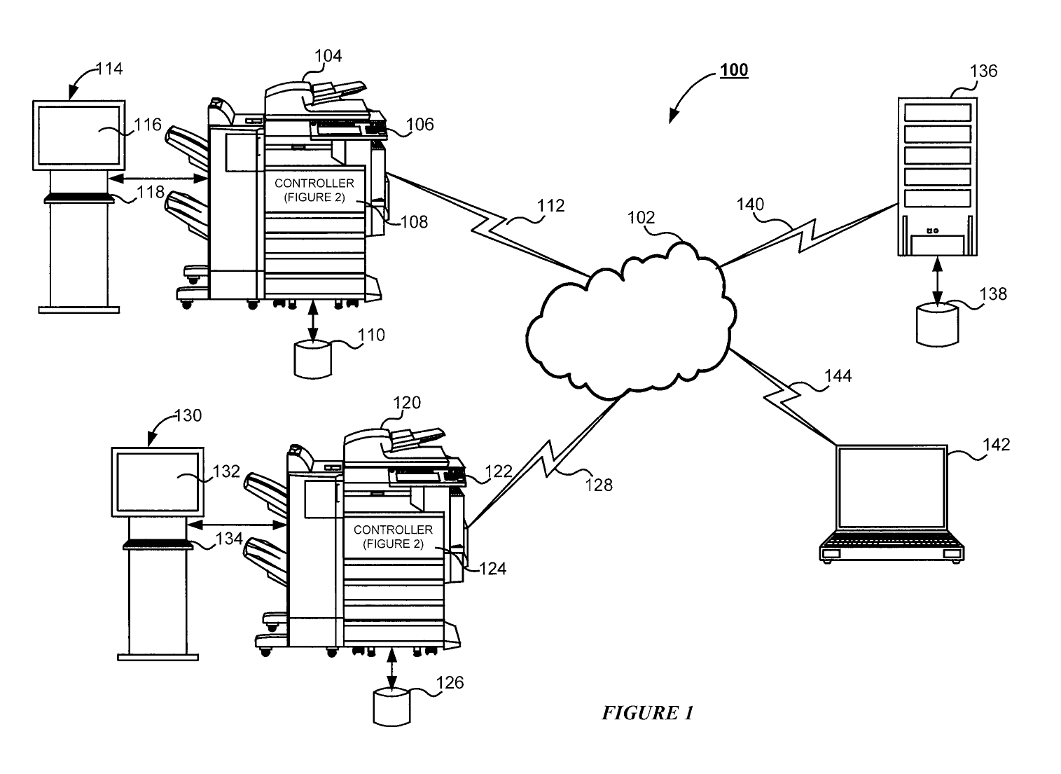

The subject application is directed to a pay station-based kiosk system and method for document processing. In particular, the subject application is directed to a system and method for providing document processing services via point-of-sale transactions. More particularly, the subject application is directed to a system and method for communicating transaction data to backend server corresponding to a document processing operation. It will become apparent to those skilled in the art that the system and method described herein are suitably adapted to a plurality of varying electronic fields employing remote transaction monitoring, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for providing document processing services via point-of-sale transactions in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

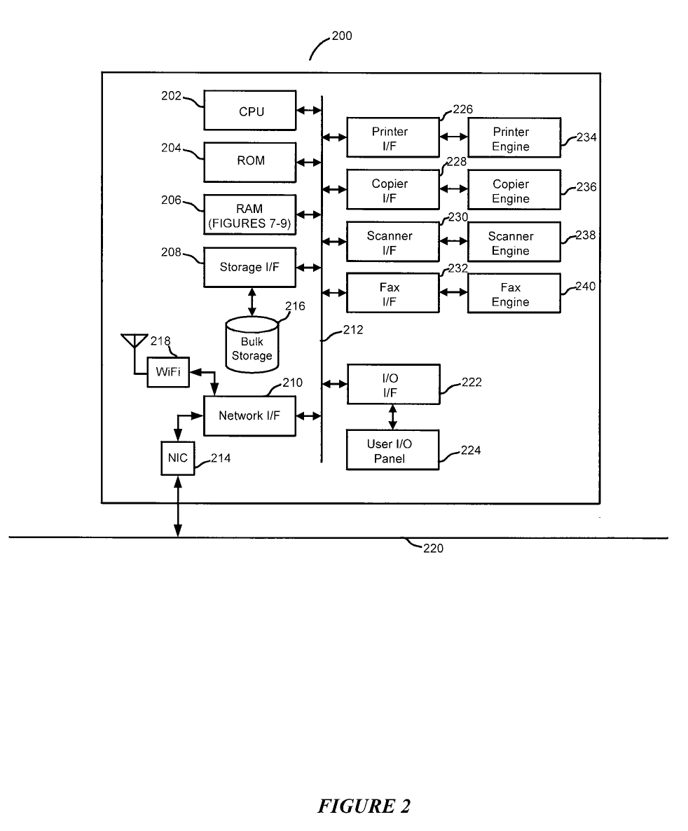

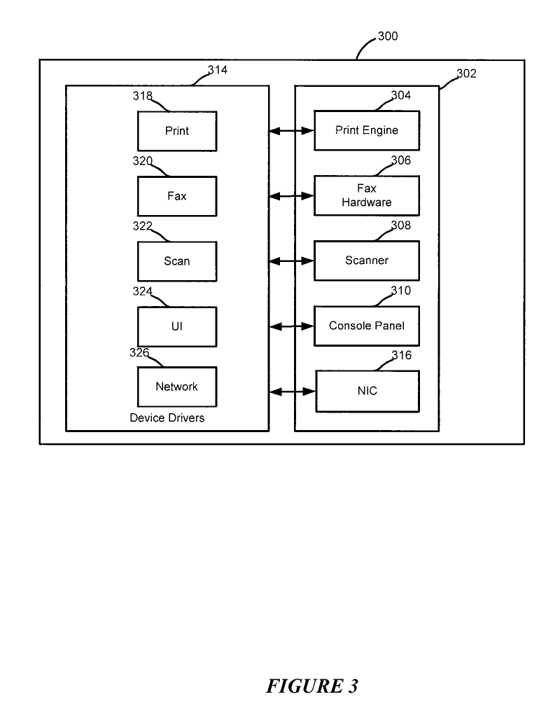

The system 100 also includes a first document processing device 104, and a second document processing device 120, each of which are depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 and 120 are suitably adapted to provide remote document processing services to external or network devices. Preferably, the document processing devices 104 and 120 include hardware, software, and any suitable combination thereof, configured to interact with an associated user, a networked device, or the like. The functioning of the document processing devices 104 and 120 will better be understood in conjunction with the block diagrams illustrated in FIGS. 2 and 3, explained in greater detail below.

According to one embodiment of the subject application, the first document processing device 104 and the second document processing device 120 are suitably equipped to receive a plurality of portable storage media, including, without limitation, Firewire drive, USB drive, SD, MMC, XD, Compact Flash, Memory Stick, and the like. In the preferred embodiment of the subject application, each document processing device 104 and 120 further includes an associated user interface 106 and 122, respectively, such as a touch-screen, LCD display, touch-panel, alpha-numeric keypad, or the like, via which an associated user is able to interact directly with the corresponding document processing device 104 or 120. In accordance with the preferred embodiment of the subject application, the user interfaces 106 and 122 are advantageously used to communicate information to the associated user and receive selections from the associated user. The skilled artisan will appreciate that the user interfaces 106 and 122 comprise various components, suitably adapted to present data to the associated user, as are known in the art. In accordance with one embodiment of the subject application, the user interfaces 106 and 122 each comprise a display, suitably adapted to display one or more graphical elements, text data, images, or the like, to an associated user, receive input from the associated user, and communicate the same to a backend component, such as controllers 108 and 124, as explained in greater detail below. Preferably, the document processing devices 104 and 120 are communicatively coupled to the computer network 102 via respective communications links 112 and 128. As will be understood by those skilled in the art, suitable communications links include, for example and without limitation, WiMax, 802.11a, 802.11b, 802.11 g, 802.11(x), Bluetooth, the public switched telephone network, a proprietary communications network, infrared, optical, or any other suitable wired or wireless data transmission communications known in the art.

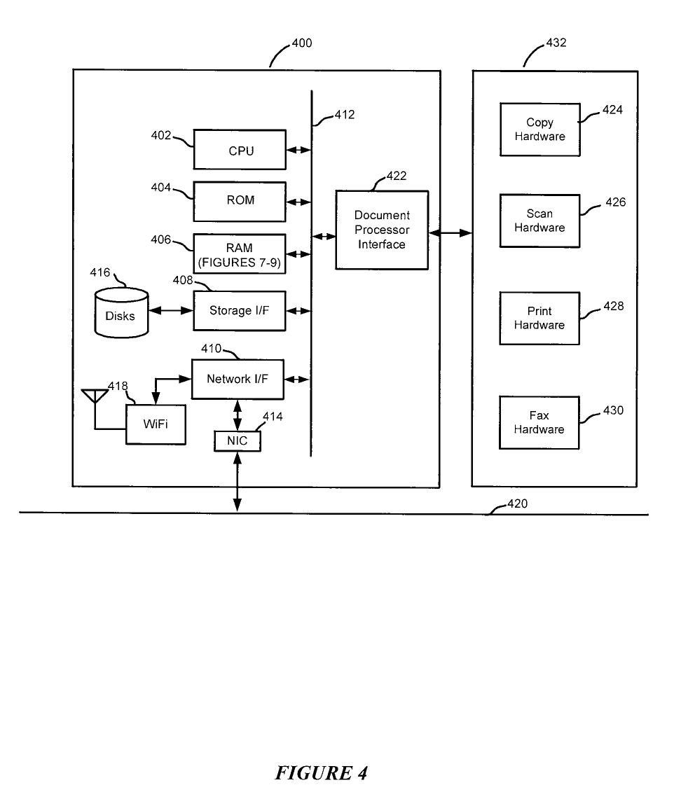

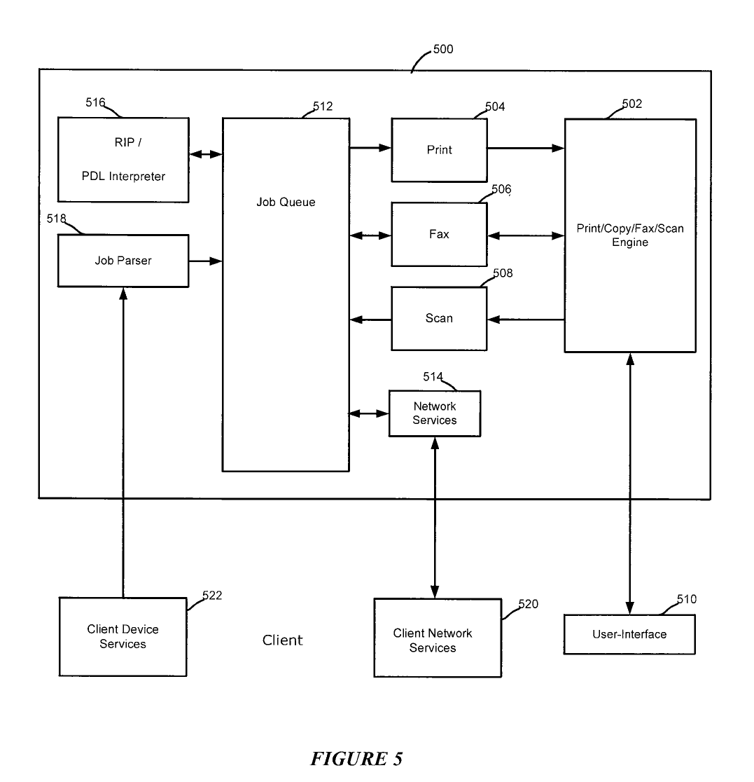

In accordance with one embodiment of the subject application, the document processing devices 104 and 120 further incorporate backend components, designated as the controllers 108 and 124, suitably adapted to facilitate the operations of the corresponding document processing device 104 and 120, as will be understood by those skilled in the art. Preferably, the controllers 108 and 124 are embodied as hardware, software, or any suitable combination thereof, configured to control the operations of the associated document processing devices 104 and 120, facilitate the display of images via the user interfaces 106 and 122, direct the manipulation of electronic image data, and the like. For purposes of explanation, the controllers 108 and 124 are used to refer to any myriad of components associated with the document processing devices 104 and 120, including hardware, software, or combinations thereof, functioning to perform, cause to be performed, control, or otherwise direct the methodologies described hereinafter. It will be understood by those skilled in the art that the methodologies described with respect to the controllers 108 and 124 are capable of being performed by any general purpose computing system, known in the art, and thus the controllers 108 and 124 are representative of such general computing devices and are intended as such when used hereinafter. Furthermore, the use of the controllers 108 and 124 hereinafter is for the example embodiment only, and other embodiments, which will be apparent to one skilled in the art, are capable of employing the system and method for pay station-based document processing of the subject application. The functioning of the controllers 108 and 124 will better be understood in conjunction with the block diagrams illustrated in FIGS. 4 and 5, explained in greater detail below.

Communicatively coupled to the document processing devices 104 and 120 are respective data storage devices 110 and 126. In accordance with the preferred embodiment of the subject application, the data storage devices 110 and 126 are any mass storage devices known in the art including, for example and without limitation, magnetic storage drives, a hard disk drive, optical storage devices, flash memory devices, or any suitable combination thereof. In the preferred embodiment, the data storage devices 110 and 126 are suitably adapted to store document data, image data, electronic database data, or the like. It will be appreciated by those skilled in the art that while illustrated in FIG. 1 as being a separate components of the system 100, the data storage devices 110 and 126 are capable of being implemented as internal storage components of the associated document processing devices 104 and 120, components of the controllers 108 and 124, or the like, such as, for example and without limitation, an internal hard disk drive, or the like. In accordance with one embodiment of the subject application, the data storage devices 110 and 126 are capable of storing common identifier data and configuration data associated with the document processing devices 104 and 120. Preferably, the configuration data comprises account information, service provider information, available document processing capabilities, and the like.

Illustrated in FIG. 1 is a first pay station-based kiosk 114, communicatively coupled to the document processing device 104, and in effect, the computer network 102. A second pay station-based kiosk 130 is also illustrated in FIG. 1 as being communicatively coupled to the second document processing device 120, and in effect, the computer network 102. It will be appreciated by those skilled in the art that the kiosks 114 and 130 are capable of being implemented as separate components of the respective document processing devices 104 and 120, or as integral components thereof. Use of the kiosks 114 and 130 in FIG. 1 are for example purposes only, and the skilled artisan will appreciate that the subject application is capable of implementation without the use of kiosk. In accordance with one embodiment of the subject application, the kiosks 114 and 130 include, respectively, displays 116 and 132, and user input devices 118 and 134. As will be understood by those skilled in the art the kiosks 114 and 130 are capable of implementing a combination user input device/display, such as a touch screen interface. According to one embodiment of the subject application, the kiosks 114 and 130 are suitably adapted to display prompts to an associated user, receive instructions from the associated user, receive payment data, and the like. Preferably, the kiosks 114 and 130 are suitably adapted to receive a portable storage media, such as a magnetic card, which includes transaction identification data. In accordance with such an embodiment, the kiosks 114 and 130 include a magnetic card reader suitably adapted to receive and read data from a portable storage device. In addition, using the connections via the associated document processing devices 104 and 120, the kiosks 114 and 130 are able to communicate, via the computer network 102, with a backend component, such as the server 136, explained in greater detail below.

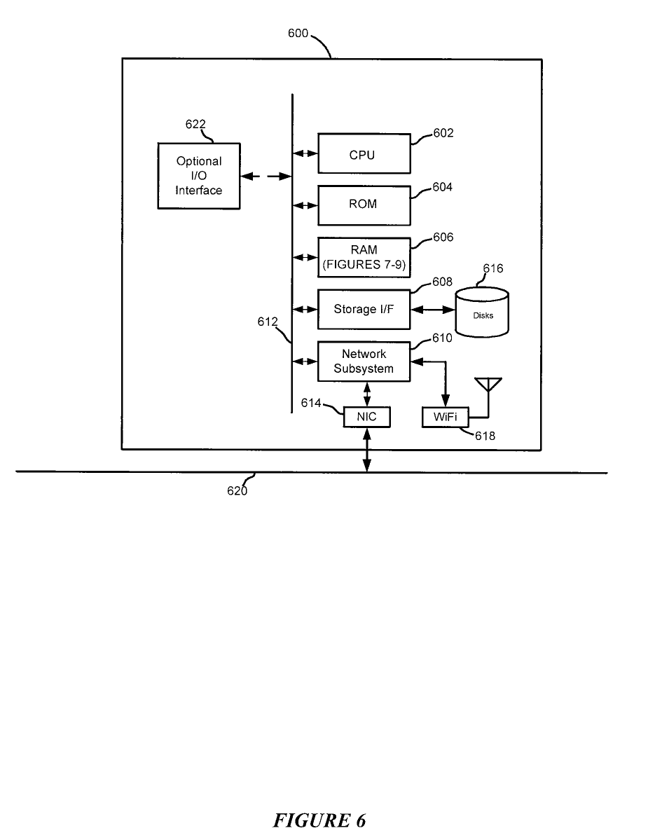

The system 100 of FIG. 1 further comprises a backend server 136 in data communication with the computer network 102 via a communications link 140. Preferably, the server 136 further includes a data storage device 138 coupled thereto. In accordance with one embodiment of the subject application, the data storage device 140 is capable of storing a plurality of databases corresponding to document processing service providers, document processing services, devices, users, payment information, and the like. The communications link 140, as will be understood by those skilled in the art, is any suitable channel of data communications known in the art including, for example and without limitation, Bluetooth, WiMax, 802.11a, 802.11b, 802.11 g, 802.11(x), a proprietary communications network, infrared, optical, the public switched telephone network, or any suitable wireless data transmission system, or wired communications. The functioning of the server 136 will better be understood in conjunction with the block diagram illustrated in FIG. 6, explained in greater detail below.

The system 100 illustrated in FIG. 1 further depicts a user device 142, in data communication with the computer network 102 via a communications link 144. It will be appreciated by those skilled in the art that the user device 142 is shown in FIG. 1 as a laptop computer for illustration purposes only. As will be understood by those skilled in the art, the user device 142 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 144 is any suitable channel of data communications known in the art including, but not limited to wireless communications, for example and without limitation, Bluetooth, WiMax, 802.11a, 802.11b, 802.11 g, 802.11(x), a proprietary communications network, infrared, optical, the public switched telephone network, or any suitable wireless data transmission system, or wired communications known in the art. Preferably, the user device 142 is suitably adapted to generate and transmit electronic documents, document processing instructions, user interface modifications, upgrades, updates, personalization data, or the like, to the document processing device 104, the document processing device 120, the server 136 or any other similar device coupled to the computer network 102. In accordance with one embodiment of the subject application, the user device 142 includes a web browser application, suitably adapted to securely interact with the document processing device 104, the document processing device 120, the server 136, or the like. The skilled artisan will appreciate that the user device 142 is also capable of implementation as an administrative device, whereupon a user associated with the device 142 is able to access, delete, view, or otherwise modify data stored on the server 136.

Turning now to FIG. 2, illustrated is a representative architecture of a suitable device 200, (shown in FIG. 1 as the first document processing device 104 and the second document processing device 120), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the first document processing device 104 and the second document processing device 120), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108 and 124, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104 and 120, which include the controller 400 of FIG. 4, (shown in FIG. 1 as the controllers 108 and 124) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

Turning now to FIG. 6, illustrated is a representative architecture of a suitable server 600, (shown in FIG. 1 as the server 136), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

In operation, at least one of a plurality of commonly controlled document processing stations receives a request for performing a document processing operation on an associated electronic document. Transaction identification data is then received from an associated portable data storage by the commonly controlled document processing station. The station then generates billing data corresponding to each document processing operation requested. The received transaction identification data is then compared with common identifier data. Billing data is then output to an associated pay station when the received transaction data matches the common identifier data. Debit data associated with the portable data storage is then output when the transaction identifier fails to match the common identifier. When the transaction identification data matches the common identifier data, billing data is output to an associated pay station.

In accordance with one example embodiment of the subject application, a document processing request is received by a document processing device 104 or 120 via an associated kiosk 114, 130, user interface 106, 122, a user device 142, or the like. Transaction identification data is then received from a portable storage device. In accordance with one embodiment of the subject application, the transaction identification data corresponds to an account number, an alphanumeric sequence of characters, or the like, which is received from a suitable portable storage device, e.g., a magnetic storage device such as, for example and without limitation a credit card, debit card, a smart card, or the like. The recipient document processing device 104 or 122, via its corresponding controller 108 or 124, then calculates the costs associated with the performance of the requested document processing operation. Billing data is thereby generated corresponding to the costs of performing the document processing request.

A determination is then made by the controller 108 or 124 associated with the recipient document processing device 104 or 120, respectively, whether the received transaction identification data is unknown. That is, whether or not the data received from the portable storage device is unintelligible, corrupted, unreadable, represents an unrecognizable account number, or the like. In the event that the received transaction identification data is unknown, an error signal is generated by the recipient document processing device 104 or 120 and communicated to the user associated with the document processing request via any suitable means known in the art including, for example and without limitation, a visual indicator on the user interface 106, 122, the display 116, 132, via electronic mail messaging, via text messaging, an audible alert, or the like.

When it is determined that the transaction identification data is not of an unknown type, format, or the like, the transaction identification data is compared to common identifier data. In accordance with one embodiment of the subject application, the common identifier data corresponds to a local account indicating a pay-at-the-counter type of transaction, i.e., where the user will provide payment for document processing services at a pay station. According to one embodiment of the subject application, the common identifier data is received from the server 136 and corresponds to the physical location of the recipient document processing device 104 or 120, a service provider associated with the recipient document processing device 104 or 120, or the like.

When the common identifier data and the transaction identification data match, the billing data is output to a pay station, whereupon the user is prompted to provide payment corresponding to the costs associated with the performance of the requested document processing operations. As will be understood by those skilled in the art, the pay station is capable of comprising, for example and without limitation, an automated payment station, an assisted pay station, a cashier, or the like. When the transaction identification data and the common identifier data do not match, debit data is output in association with the portable storage device. That is, the credit card account, personal account, pre-paid account, or the like, represented by the transaction identification data is debited in accordance with the costs associated with the performance of the requested document processing operations. The skilled artisan will appreciate that debiting, as used herein, includes, for example and without limitation, charging a credit-based account, deducting from a prepaid account, charging a business account, charging a personal account, or the like.

In accordance with one example embodiment of the subject application, a server 136 receives common identifier data corresponding to account data representative of an account associated with a service provider. As will be appreciated by those skilled in the art, the service provider provides facilities and services corresponding to fee-based document production, management, storage, communication, devices, and the like. In accordance with one embodiment of the subject application, the service provider includes kiosks 114 and 130 coupled, respectively, to document processing devices 104 and 120, via which a user is able to request the performance of document processing operations. Preferably, the kiosk/device is located in a facility operated by the service provider inclusive of a plurality of such kiosks/devices, thereby providing document processing services to a plurality of users. The common identifier data in this example embodiment preferably includes data representative of a 16-digit account number, corresponding to a prepaid account. The server 136 then receives service provider location identification data representing the location of the service provider, and the document processing device 104.

The received account data is then stored in association with the service provider identification data by the server 136 in an associated database. The server 136 then communicates the associated data to the document processing devices 104 and 120, thereby selectively modifying configuration data associated therewith. Preferably the configuration data includes, for example and without limitation, the common identifier data, account data corresponding to the service provider, location data, and other document processing device configuration data, as will be appreciated by those skilled in the art.

According to another example embodiment of the subject application, the first document processing device 104 receives, via the computer network 102, configuration update data from the server 136. The controller 108 associated with the document processing device 104 then updates the configuration data in accordance with the configuration data received from the server 136. In accordance with one embodiment of the subject application, the configuration data received from the server 136 includes common identifier data. According to a further embodiment of the subject application, the configuration data also includes an account number associated with the service provider location at which the document processing device 104 is located. According to another embodiment, the account number corresponds to an account that is capable of being used at a plurality of service provider locations.

When a user logs onto the document processing devices 104 or 120 via the user interfaces 106 or 122, the kiosks 114 or 130, the user device 142, or the like, the user is prompted to select a desired document processing operation. As will be understood by those skilled in the art, suitable document processing operations include, for example and without limitation, an electronic mail operation, a copying operation, a scan-to-storage operation, a scan-to-electronic mail operation, a facsimile operation, a print operation, or the like. The controllers 108 or 124, kiosks 114 or 130, or other suitable device then determines, based on the document processing request, any charges associated with performing the requested operation. This cost is then displayed to the user via the user interfaces 106 or 122, the displays 116 or 132, the user device 142, or the like. The skilled artisan will appreciate that a user is capable of requesting document processing operations remotely, via a secure web portal at the user device 142, thus requesting the operation and accepting the charges being performed at the user device 142.

Transaction identification data is then received from the user in the form of a credit card, username/password association, prepaid card, or the like. It will be appreciated by those skilled in the art that the user is capable of inputting, for example, an account number associated with a business to which services are charged, a credit card number, an account number associated with a prepaid account or the like. The entry of such data, as the skilled artisan will appreciate, is capable of occurring via a magnetic card reader (not shown) associated with the document processing devices 104 120, the kiosks 114, 130, or the like, or entered manually via a suitable keyboard, e.g., the user device 142, the user interfaces 106, 122, the user input devices 118, 134, or the like. A determination is first made whether or not the received transaction identification data represents unknown data, e.g., whether the data is corrupted, unintelligible, unrecognizable, or the like. In such an event, the recipient document processing device 104 or 120, via a suitable component thereof, generates an error signal to the user indicative of the error.

When the transaction identification data is not unknown, the controller 108, 124, kiosk 114, 130, or other suitable component associated with the recipient document processing device 104 or 120 then determines whether the transaction identification data received from the user corresponds to prepaid account, a credit card account, a user account, e.g., a business account, personal account, or the like, or the like. When the transaction identification data corresponds to a credit card or user account, the charges are presented to the user for acceptance. Once acceptance has been received, the document processing device 104 performs the requested operation and charges the corresponding account. In accordance with the preferred embodiment of the subject application, the charging of the account also includes the communication of transaction details associated with the performed document processing operation to the server 136 for storage in an associated database on the storage device 138.

When it is determined that the transaction identification data corresponds to a prepaid account, the controller 108, 124, the kiosk 114, 130, or other suitable component associated with the recipient document processing device 104 or 120 retrieves common identifier data in the configuration file corresponding to an account number associated with the service provider location at which the recipient document processing device 104 or 120 is located. That is, the configuration file includes an account number, e.g., a 16 digit account number, which indicates to the recipient document processing device 104 or 120 that any requested document processing operations requested by the user associated with the received payment data is to be paid for by the user at a point-of-sale location in the service provider location, e.g., a cashier. In accordance with one embodiment of the subject application, the configuration file is capable of including a second account number, which indicates a prepaid card that is acceptable at a plurality of service provider locations, as opposed to the first example, which is associated solely with a single service provider.

When the transaction identification data received from the user and the account information stored in the configuration file match, the user interface 106 or 122, the display 116 or 132, or the user device 142, display a prompt to the user indicating that the operation is a “pay at the counter” operation, i.e., the user must pay for the charges associated with the recipient document processing device 104 or 120 at a service counter located in the service provider location. The requested document processing operation is then performed by the recipient document processing device 104 or 120 and the transaction details, e.g., type of operation, resources used, cost, etc., are communicated to the server 136 for storage in the database associated therewith.

When the received payment data and the account data from the configuration file do not match, the payment data is communicated, via the computer network 102, to the server 136. The skilled artisan will appreciate that the server 136 is capable of retrieving, from the data storage device 138, data representative of an account balance, user information, and the like, corresponding to the received payment data. The document processing device 104, via the controller 108 or kiosk 114, then receives the balance remaining on the prepaid account from the server 136 and displays this to the user via the user interface 106, display 116, or the like. Once the user accepts the charges, the document processing operation is performed by the recipient document processing device 104 and the debit of the account is communicated to the server 136 for storage in the associated database 138.

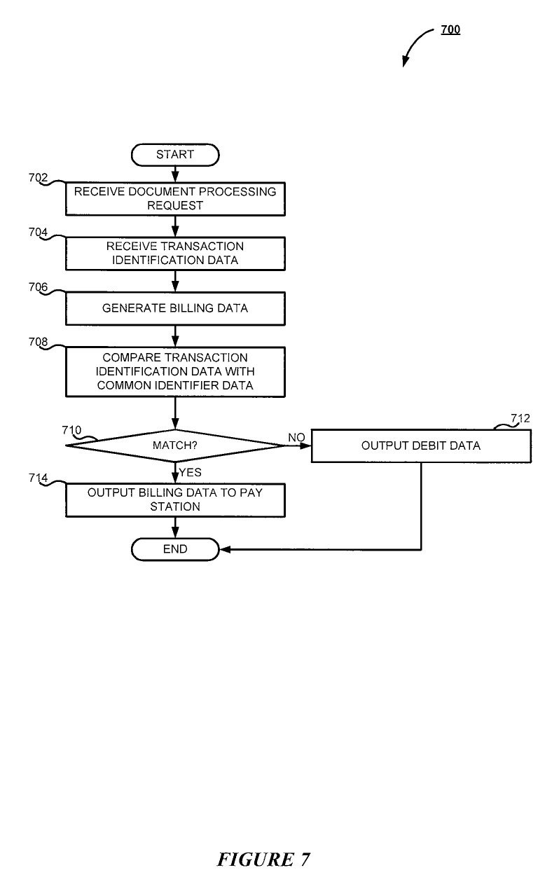

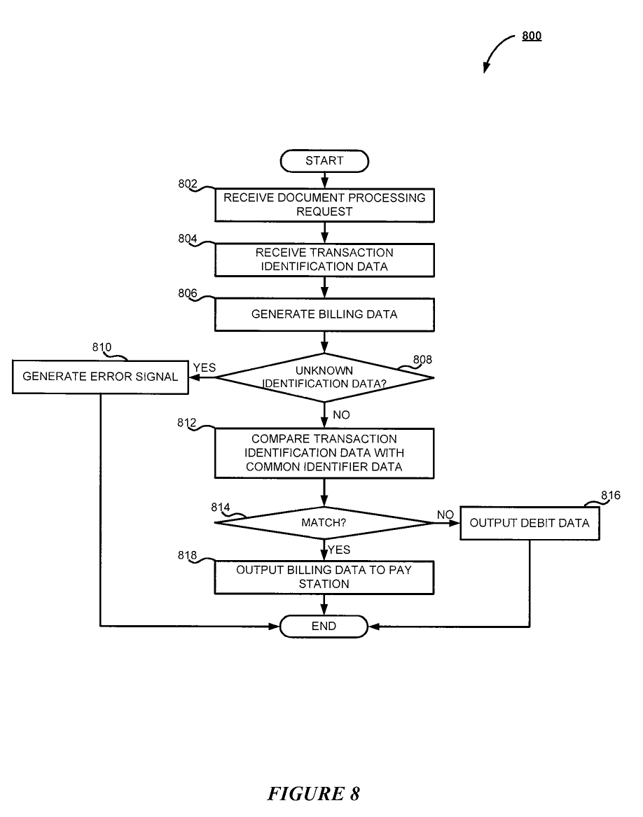

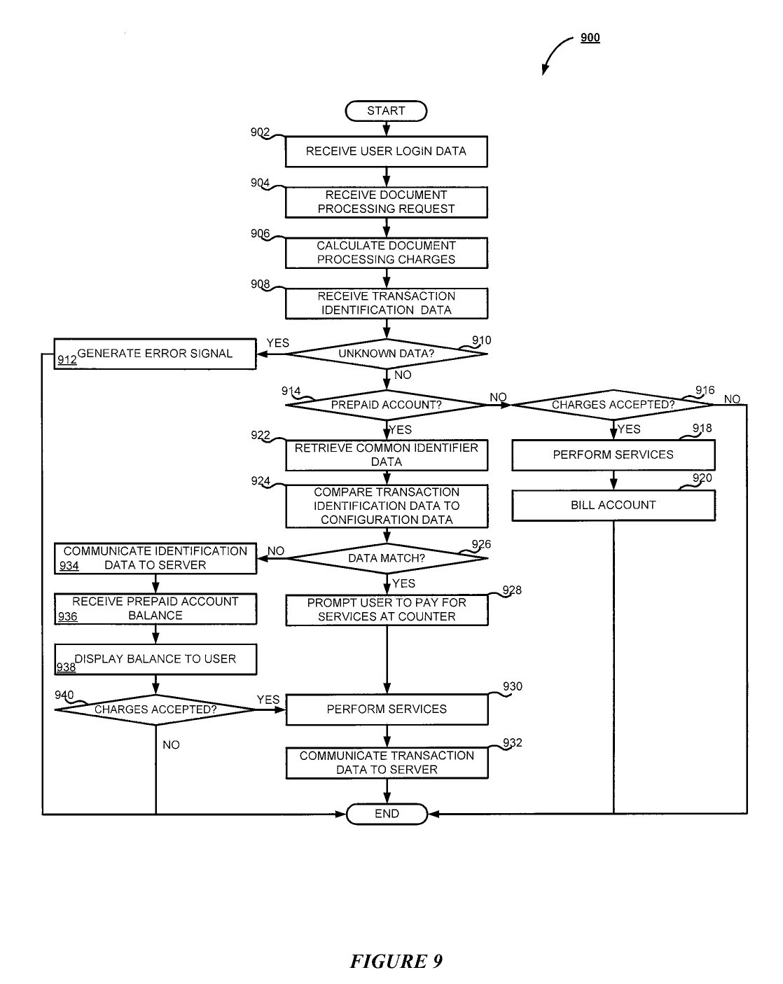

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7, FIG. 8, and FIG. 9. Turning now to FIG. 7, there is shown a flowchart 700 illustrating a pay station-based kiosk document processing method in accordance with one embodiment of the subject application. Beginning at step 702, a commonly controlled document processing station, illustrated in FIG. 1 as the document processing devices 104 and 120, receives a request to perform a document processing operation on an associated electronic document. For purposes of explanation only, reference is made hereinafter to a user selecting the first document processing device 104 and first kiosk 114. The skilled artisan will appreciate that an associated user is capable of using any of the plurality of document processing stations as illustrated in FIG. 1 in accordance with the method expressed in the flowchart 700 of FIG. 7.

Transaction identification data is then received, at step 704, from an associated portable data storage by the document processing device 104. It will be appreciated by those skilled in the art that the associated user is capable of providing the portable data storage in the form of a magnetic card, which is read by a card reader associated with the kiosk 114, the document processing device 104, or the like. In such an embodiment, the transaction identification data is communicated from the card reader to the document processing device 104 for further processing. At step 706, the controller 108, the kiosk 114, or other device/component associated with the document processing device 104 generates billing data corresponding to each document processing operation requested.

The received transaction identification data is then compared at step 708 with common identifier data. Preferably, the common identifier data is stored in association with the document processing device 104, e.g., in the data storage device 110. In accordance with one embodiment of the subject application, the common identifier data corresponds to account information. A determination is then made at step 710 whether the transaction identification data matches the common identifier data. When it is determined, at step 710, that the transaction identification data does not match the common identifier data, flow proceeds to step 712, whereupon debit data associated with the portable storage is then output. For example, when the portable storage is a credit card or prepaid card, the account associated with the card is charged or debited the billing amount generated at step 706. When a match is determined at step 710, the billing data calculated at step 706 is output to an associated pay station.

Turning now to FIG. 8, there is shown a flowchart 800 illustrating an example implementation of the pay station-based kiosk document processing method in accordance with one embodiment of the subject application. The method of FIG. 8 begins at step 802, whereupon a document processing request is received by a document processing device 104 or 120 via an associated kiosk 114, 130, user interface 106, 122, a user device 142, or the like. For purposes of this example implementation, reference is made hereinafter to the first document processing device 104 and its associated components, e.g., the kiosk 114, the user interface 106, the controller 108, the data storage device 110, and the like.

The document processing device 104 then receives transaction identification data from a portable data storage at step 804. According to one embodiment of the subject application, the transaction identification data includes an account number, an alphanumeric sequence of characters, or the like. In accordance with such an embodiment of the subject application, a suitable portable storage device includes, for example and without limitation, a magnetic storage device such as, a credit card, debit card, a smart card, or the like. At step 806, the document processing device 104, via controller 108 or kiosk 114, then determines the expenses associated with the performance of the requested document processing operation by generating billing data.

A determination is then made by the controller 108 at step 808 whether the received transaction identification data is unknown. Stated another way, a determination is made whether or not the received transaction identification data is corrupted, unreadable, unintelligible, representative of an unrecognizable account number, or the like. When it is determined at step 808 that the transaction identification data is unknown, flow proceeds to step 810, whereupon an error signal is generated by the document processing device 104. In accordance with one embodiment of the subject application, the error signal is thereafter communicated to the user associated with the document processing request via any suitable means known in the art including, for example and without limitation, a visual indicator on the user interface 106, the display 116, via electronic mail messaging, via text messaging, an audible alert, or the like.

When it is determined at step 808 that the transaction identification data is not unknown, flow proceeds to step 812, whereupon the received transaction identification data is compared to common identifier data. In accordance with one embodiment of the subject application, the common identifier data corresponds to a local account indicating a pay-at-the-counter type of transaction, i.e., the user provides payment for the document processing services at a pay station. When it is determined at step 814 that the common identifier data and the received transaction identification data do not match, flow proceeds to step 816, whereupon debit data is output in association with the portable storage device. In accordance with one embodiment of the subject application, a credit card account, personal account, pre-paid account, or the like, represented by the transaction identification data, is debited in accordance with the costs associated with the performance of the requested document processing operations. When it is determined at step 814 that the common identifier data and the received transaction identification data match, flow proceeds to step 818, whereupon the billing data is output to a pay station. It will be appreciated by those skilled in the art that thereafter, the user is prompted to provide payment corresponding to the costs associated with the performance of the requested document processing operations. As will be understood by those skilled in the art, the pay station is capable of comprising, for example and without limitation, an automated payment station, an assisted pay station, a cashier, or the like.

Referring now to FIG. 9, there is shown a flowchart 900 describing an example implementation of the method set forth above. For example purposes only, reference is made hereinafter with respect to FIG. 9 of operations performed via the second document processing device 120. The example implementation of FIG. 9 begins at step 902, whereupon the controller 124, via the user interface 122, or the kiosk 130 via the input device 134, receives user login data. In accordance with one particular embodiment of the subject application, the login data corresponds to a user name and/or password, which are used to retrieve data about the user from the server 136, from local storage, or the like. It will be appreciated by those skilled in the art that use of a prepaid account requires some form of login data, including, for example and without limitation, swiping of a prepaid account magnetic card, or the like. The skilled artisan will further appreciate that the implementation described in FIG. 9 is capable of operations without requiring a user to first log onto the document processing device 120, without departing from the scope of the subject application.

At step 904, the document processing device 122 receives a document processing request corresponding to a desired document processing operation to be performed by the document processing device 120 from the associated user. The controller 124, kiosk 130, or other suitable component associated with the document processing device 120 then calculates, at step 906, any charges associated with the performance of the requested document processing operation. It will be appreciated by those skilled in the art that the cost to the user for performance of the requested operation is capable of being based upon, for example and without limitation, size of a document, type of operation, toners or ink used, resource usage, storage length, file size, distance for communication, and the like. Preferably, the calculated document processing charges are then displayed to the user for acceptance via the user interface 122, the display 132, or the like.

Transaction identification data is then received at step 908 corresponding to selected payment data from the associated user. In accordance with one embodiment of the subject application, suitable transaction identification data includes, for example and without limitation, a prepaid account data, credit card data, a billable account data associated with a user, business, department, or the like, or other data, as will be understood in the art. A determination is then made at step 910 whether the received transaction data is unknown. When the data is unknown, flow proceeds to step 912, whereupon an error signal is generated and communicated to the user. When the received transaction data is not unknown, flow proceeds to step 914, whereupon a determination is made whether the transaction identification data received corresponds to a prepaid account, i.e., an account recognized by the controller 124, kiosk 130, or the like, as not corresponding to an account to which services are billed (credit card account or other billable account).

When it is determined at step 914 that the received transaction identification data does not include a prepaid account number, flow proceeds to step 916, whereupon a determination is made whether or not the user has accepted the charges associated with the performance of the requested document processing operation. When the charges are not accepted, the operation terminates. When the charges are accepted, the document processing device 120 performs the requested services at step 918. Thereafter, the controller 124, kiosk 130, or other suitable component associated with the document processing device 120 communicates the received payment data to the server 136 for billing of the credit card account, added to a bill corresponding to a user, business, or department account, or the like, at step 920, whereafter operations terminate.

Returning to step 914, when the kiosk 130, controller 124, or the like determines that the transaction identification data received from the user corresponds to a 16-digit account number recognizable as a prepaid account number, and not a credit card number, flow proceeds to step 922, whereupon the common identifier data is retrieved. The transaction identification data is then compared with the common identifier data at step 924 to determine, at step 926, whether the account numbers match. That is, whether or not the 16-digit account number represented by the transaction identification data corresponds to the 16-digit account number represented by the common identifier data. When the transaction identification data and the common identifier data match, flow proceeds to step 928, whereupon the user interface 122, the display 132, or the like, prompts the user to pay for services at the point-of-sale location upon completion of the requested services. The document processing device 120 then performs the requested operation at step 930. The details regarding the transaction, i.e., cost, resources, device identification information, time/date, service provider identification information, etc., are gathered and communicated to the server 136 at step 932 via the computer network 102 for storage thereon in a database associated with the data storage device 138. Preferably, the data corresponding to the transaction just completed is stored in association with service provider identification data, so as to enable later accounting of transactions, for example, on a per provider basis.

Returning to step 926, a determination that the common identifier data and the transaction identification data do not match prompts the controller 124, kiosk 130, or the like to communicate the received transaction identification data to the server 136 at step 934. In accordance with one embodiment of the subject application, the server 136 receives the transaction identification data, accesses a database stored on the storage device 138, and retrieves account information corresponding to the transaction identification data received from the document processing device 120. It will be appreciated by those skilled in the art that such information suitably includes, for example and without limitation, an account balance corresponding to an amount of money which remains in the account. The remaining balance is then returned to the document processing device 120 at step 936. The remaining balance is then displayed via the user interface 122 or display 132 to the user at step 938 indicating the amount of money left on the prepaid card.

A determination is then made at step 940 whether the charges, as calculated at step 906 for the performance of the requested document processing operation, have been accepted by the associated user. That is, whether or not the user has agreed to have the account designated by the prepaid card debited in the amount calculated for the performance of the document processing operation. When the charges are rejected by the user, the operation terminates. In accordance with one embodiment of the subject application, the controller 124, kiosk 130, or the like, determines whether the amount remaining on the prepaid card is sufficient to cover the charges for the requested operation. When the level of the prepaid card is insufficient, the user is prompted to either cancel the operation, or select a new payment method. Once the charges have been accepted by the user at step 940, flow proceeds to step 930, whereupon the document processing device 120 performs the requested document processing operation. The details regarding the transaction, i.e., cost, resources, device identification information, time/date, service provider identification information, etc., are gathered and communicated to the server 136 at step 932 via the computer network 102 for storage thereon in a database associated with the data storage device 138. As set forth above, the data corresponding to the transaction is preferably stored in association with service provider identification data, thereby enabling later accounting of transactions, for example, on a per provider basis, on a per document processing device basis, on a per location basis, or the like.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A pay station-based kiosk document processing system comprising:
a plurality of commonly controlled document processing document processing stations, each document processing station including, means adapted for performing at least one document processing operation on at least one selected electronic document,
means adapted for generating fee data corresponding with each document processing operation,
means adapted for accessing common identifier data, means adapted for receiving transaction identifier data from a portable data storage,
means adapted for outputting billing data when the transaction identifier data matches the common identifier data; and
means adapted for communicating debit data associated with the portable data storage when the transaction identifier fails to match the common identifier data;
a pay station associated with each of the document processing stations, the pay station including means adapted for receiving billing data from each of the document processing stations.

2. The pay station-based kiosk document processing system of claim 1 further comprising means adapted for generating an error signal when the transaction identifier data corresponds to unknown identifier data.

3. The pay station-based kiosk document processing system of claim 1 further comprising means adapted for selectively outputting the billing data to the pay station upon receipt of a request from an associated user.

4. The pay station-based kiosk document processing system of claim 1 wherein the portable data storage is comprised of a pre-paid debit card.

5. The pay station-based kiosk document processing system of claim 1 wherein the billing data includes data corresponding to a completed document processing operation.

6. The pay station-based kiosk document processing system of claim 1 wherein the pay station includes means adapted for receiving payment associated with received billing data.

7. A method for pay station-based document processing comprising the steps of:
receiving, on at least one of a plurality of commonly controlled document processing stations, a request for performing at least one document processing operation on an associated electronic document;
receiving, on at least one of the plurality of commonly controlled document processing stations, transaction identification data from an associated portable data storage;
generating, on at least one of a plurality of commonly controlled document processing stations, billing data corresponding with each document processing operation;
comparing received transaction identification data with common identifier data;
outputting billing data to an associated pay station when received transaction data matches the common identifier data;
outputting debit data associated with the portable data storage when the transaction identifier fails to match the common identifier data.

8. The method for pay station-based kiosk document processing of claim 7 further comprising the step of generating an error signal when the transaction identifier data corresponds to unknown identifier data.

9. The method for pay station-based kiosk document processing of claim 7 further comprising the step of selectively outputting the billing data to the pay station upon receipt of a request from an associated user.

10. The method for pay station-based kiosk document processing of claim 7 wherein the portable data storage is comprised of a pre-paid debit card.

11. The method for pay station-based kiosk document processing of claim 7 wherein the billing data includes data corresponding to a completed document processing operation.

12. The method for pay station-based kiosk document processing of claim 7 wherein the pay station includes means adapted for receiving payment associated with received billing data.

13. A computer-implemented method for pay station-based document processing comprising the steps of:
receiving, on at least one of a plurality of commonly controlled document processing stations, an request for performing at least one document processing operation on an associated electronic document;
receiving, on at least one of the plurality of commonly controlled document processing stations, transaction identification data from an associated portable data storage;
generating, on at least one of a plurality of commonly controlled document processing stations, billing data corresponding with each document processing operation;
comparing received transaction identification data with common identifier data;
outputting billing data to an associated pay station when received transaction data matches the common identifier data;
outputting debit data associated with the portable data storage when the transaction identifier fails to match the common identifier data.

14. The computer-implemented method for pay station-based kiosk document processing of claim 13 further comprising the step of generating an error signal when the transaction identifier data corresponds to unknown identifier data.

15. The computer-implemented method for pay station-based kiosk document processing of claim 13 further comprising the step of selectively outputting the billing data to the pay station upon receipt of a request from an associated user.

16. The computer-implemented method for pay station-based kiosk document processing of claim 13 wherein the portable data storage is comprised of a pre-paid debit card.

17. The computer-implemented method for pay station-based kiosk document processing of claim 13 wherein the billing data includes data corresponding to a completed document processing operation.

18. The computer-implemented method for pay station-based kiosk document processing of claim 13 wherein the pay station includes means adapted for receiving payment associated with received billing data.
